(19) United States
(12) Patent Application Publication
(10) Pub. No.: US 2015/0367153 A1
(43) Pub. Date: Dec. 24, 2015

(54) SELF-EXTINGUISHING RECEPTACLE

(71) Applicant: The Boeing Company, Huntington Beach, CA (US)

(72) Inventor: Raymond J. Slesinski, Arnold, MO (US)

(21) Appl. No.: 14/308,967

(22) Filed: Jun. 19, 2014

(51) Int. Cl. A62C 13/62; A62C 3/00

(52) U.S. Cl. CPC A62C 13/62; A62C 3/00

(57) ABSTRACT

Methods and apparatuses are disclosed for controlling and extinguishing ignited or ignitable metals and/or metal-containing compounds in a container comprising predetermined amounts of releasable fire suppressant.

### FIELD

This disclosure relates generally to methods and apparatuses used to extinguish ignited or ignitable materials. More particularly, the present disclosure relates to methods and apparatuses used to extinguish ignited or ignitable metals and/or metal-containing compounds.

### BACKGROUND

Damage from fires remains costly and potentially dangerous. In a commercial environment, loss of equipment, inventory as well as injury to workers remains a serious concern. Waste receptacle fires can be particularly dangerous and destructive if not extinguished quickly. Previous solutions have either required human intervention to suppress the fire, or an element of the fire itself (heat, smoke, etc.) is responsible for triggering the operation of a fire suppression system to release a compound to the environment (e.g. water, halon, or other fire suppressant, etc.). However, in many instances, the widespread release of a fire suppressant from a fire suppression system can, itself, cause significant damage.

In addition, certain fires are not easily overcome with standard fire suppressants. For example, so-called Class D fires result from the ignition of metals and metal-containing compounds. Class D fires burn at a high temperature and do not respond well to the types of fire suppressants used to combat other fire types (Class A “Ash”—wood, paper, etc.; or Class B “Barrel”—petroleum, gasoline, oil, etc.; Class C—“Flammable Gases”; Class E—“Electrical”; Class K—“Kitchen Oils and Fats). In fact, the high velocity CO₂ and/or water used to combat Class A fires, and the high velocity dry chemical compounds that are designed to interrupt the chemical reactions for Class B fires, for example, are all specifically not rated for use in combating Class D fires, and often exacerbate the flames of a Class D fire.

Class D fires rely on a fire retardant being provided to the fire: 1) in a low velocity so as to not spread the area of the fire, and 2) in a sufficient amount such that the fire suppressant is applied thickly to the fire so as to form a crust that effectively smothers the fire by cutting off the direct supply of oxygen to the fire.

As a result, Class D fires must typically be fought by a human responder, since it is difficult for an automated system to determine how much suppressant is required, or if enough suppressant has been delivered to the fire to completely interrupt the oxygen supply to the fire.

In addition, if a Class D fire occurs in a waste receptacle designed to collect metal particulate, for example, from a machining function, and the fire is allowed to burn, and otherwise goes unnoticed, the fire may breach the waste receptacle and spread to surrounding areas in an uncontrolled fashion. Further, even if a Class D fire in a waste receptacle is detected quickly, if the proper fire suppressant is not readily available, the fire may quickly spread beyond the confines of the receptacle.

### SUMMARY

In one aspect, the present disclosure is directed to a container comprising an inner surface and an outer surface, and a system for suppressing a fire occurring in the container. The system is in communication with the inner surface, and the system comprises a predetermined amount of deployable fire suppressant material.

According to an aspect of the disclosure, the fire suppressant material is located adjacent to the inner surface of the container.

A further aspect of the disclosure is directed to a container, preferably comprising a body section and a lid section in communication with the body section. The lid section comprises a first side and a second side with a retainer in communication with the lid section second side and the retainer dimensioned to retain a predetermined amount of fire suppressant material. In a further aspect, the lid section comprises a retainer, and the retainer provides at least a partial boundary for a cavity located in the second side of the lid section.

According to a further aspect, the container comprises a lid section with the lid section comprising an inner and outer surface, with the inner surface comprising an amount of fire suppressant material.

Still further, aspects of the present disclosure are directed to a container further comprising a retainer dimensioned to retain a predetermined amount of fire suppressant material with the retainer being in communication with the inner surface of the container.

In a further aspect, the retainer is integrated in an element dimensioned to fit within the container. Preferably, the element may be self-supporting.

In a still further aspect, the retainer is integral with the inner surface of the container.

In a further aspect, the retainer comprises a mesh section and, in a further aspect, the mesh section is made from a metal-containing or a non-metal containing material, or combinations thereof.

According to a further aspect, the container is in communication with a source of metal debris to be contained within the container.

In a further aspect, the retainer provides a partial boundary for a cavity located in the inner surface of the container and/or the second side of the lid section.

In a further aspect, the metal debris comprises a metal including magnesium, potassium, titanium, zirconium, aluminum, lithium, calcium, and combinations thereof.

In a still further aspect, the fire suppressant material includes a material such as, for example, dry soda ash, sand, dry sodium chloride, dry sodium chloride-containing compounds, graphite powder, graphite-containing compounds, and combinations thereof.

In yet another aspect, the retainer is integral with the lid. Still further, in another aspect, the retainer provides a partial boundary for a cavity located in the second side of the lid section.

In a further aspect, the retainer further comprises a mesh segment that is preferably perforated or otherwise configured to allow a particulate material to pass there through. The mesh segment may be made from a metal, a metal-containing material, a non-metal-containing material, such as, for example, steels and steel alloys, stainless steels, refractory materials, concrete, ceramics (including cast ceramics and ceramic woven fibers, etc.), glass, asbestos, mineral wool fabrics, silica woven fabrics, fire-proof fibers (including Kevlar, Nomex, etc.), composite materials, etc. and combinations thereof. It is further contemplated that certain of the materials listed immediately above may be commonly available in cloth form and could be woven into a screen-like or other configuration as desired, etc.

In a further aspect of the present disclosure, the fire suppressant is encapsulated, and the suppressant is preferably encapsulated in an encapsulating material, with the encapsulating material preferably having a melting point of from about 250° F. to about 2200° F., more specifically from about 250° F. to about 1000° F., and more specifically from about 250° F. to about 500° F. In this way, aspects of the present disclosure contemplate that the encapsulating material may be selected to rupture when material within the container approaches or has achieved a “smoldering temperature”, or other desired temperature that is less than an ignition temperature, or to the point of actual flames.

In another aspect, the encapsulating material comprises a compound including, for example, polyethylene, polypropylene, poly(vinylchloride), polyurethane, polystyrene, poly(vinylacetal), paraffin, etc., and combinations thereof.

In a still further aspect, the fire suppressant material comprises a binding material such as, for example, a wax, or wax-containing compound, paraffin, etc., alone or in combination with other materials. The binding material may or may not also be an encapsulating material.

In a still further aspect, the fire suppressant is a known Class D fire suppressant.

In a further aspect, the disclosure is directed to methods for suppressing a fire within a container comprising the steps including: 1) providing a container comprising an inner surface and an outer surface; 2) providing an amount of fire suppressant to a location within the container, with a source of flammable material contained within the container; 3) collecting an amount of a flammable material in the container, with the flammable material having an ignition temperature; and 4) releasing an amount of fire suppressant material onto the flammable material when the temperature within the container is at about or in excess of predetermined temperature such as, for example, at about or in excess of a smoldering or ignition temperature of a flammable material.

Still further, aspects of the present disclosure are directed to methods for suppressing a fire within a container, comprising steps including: 1) providing a container, with the container comprising a body section, a lid section in communication with the body section, and with the lid section comprising a first side and a second side, and a retainer in communication with the lid section second side, with the retainer dimensioned to retain a predetermined amount of fire suppressant material; 2) collecting an amount of a flammable material in the container, with the flammable material having an ignition temperature; and 3) releasing an amount of fire suppressant material from the retainer and onto the flammable material when the temperature within the container is at about or in excess of the ignition temperature of the flammable material.

In a further aspect, the container is in communication with a source of flammable material to be contained within the container.

Still further, the flammable material is metal debris including magnesium, potassium, titanium, zirconium, aluminum, lithium, calcium, and combinations thereof.

In a still further aspect, the fire suppressant material comprises materials including dry soda ash, sand, dry sodium chloride, dry sodium chloride-containing compounds, graphite powder, graphite-containing compounds, and combinations thereof.

According to still further aspects, the container comprises a retainer dimensioned to retain a predetermined amount of fire suppressant material, with the retainer positioned in a predetermined location in the container.

In yet another aspect, the retainer is attached to the inner surface of the container.

In another aspect, the retainer is integral with the lid.

Still further, in another aspect, the retainer provides a partial boundary for a cavity located in the second side of the lid section.

In a further aspect, the retainer further comprises a mesh segment that is preferably perforated or otherwise configured to allow a predetermined amount of a particulate material to pass there through. The mesh segment may be made from a metal, a metal-containing material, a non-metal containing compound, a refractory material, etc., and combinations thereof.

According to further aspects, the fire suppressant material is encapsulated in an encapsulating material.

In a further aspect, the fire suppressant material comprises a binding material such as, for example, a wax, or wax-containing compound, paraffin, etc., alone or in combination with other materials. The binding material may or may not also be an encapsulating material.

In a still further aspect of the present disclosure, the fire suppressant is encapsulated, and the suppressant is preferably encapsulated in an encapsulating material, with the encapsulating material preferably having a melting point of from about 250° F. to about 2200° F.

In another aspect, the encapsulating material comprises a material including, for example, polyethylene, polypropylene, poly(vinylchloride)polyurethane, polystyrene, poly(vinylacetal), paraffin, and combinations thereof.

In a still further aspect, the fire suppressant is a known Class D fire suppressant.

Still further, aspects of the present disclosure are directed to methods of suppressing a metal fire in a container comprising the use of a container comprising an inner surface and an outer surface, and a system for suppressing a fire occurring in the container. The system is in communication with the inner surface, and the system comprises a predetermined amount of deployable/releasable fire suppressant material.

In another aspect, the present disclosure is directed to apparatuses comprising a container having an inner surface and an outer surface, and a system for suppressing a fire occurring in the container. In a further aspect, the system is in communication with the inner surface, and the system comprises a predetermined amount of deployable/releasable fire suppressant material.

### BRIEF DESCRIPTION OF THE DRAWINGS

These and other aspects of the disclosure will become more apparent to those of ordinary skill in the field, and are described in greater detail in the description and accompanying drawings wherein:

FIG. 1 illustrates a perspective view of one aspect of the present disclosure showing a container with lid attached;

FIG. 2 illustrates a top view of the lid attached to the container shown in FIG. 1;

FIG. 3 illustrates a view of the underside of the lid shown in FIG. 2;

FIG. 4 illustrates a perspective view of a packet held in place to the underside of the lid shown in FIG. 3;

FIG. 5 illustrates an exposed view of the container shown in FIG. 1 in which a fire is burning;

FIG. 6 illustrates a metal milling station with metal debris directed to a metal debris receiving container;

FIG. 7 illustrates a perspective view of an additional aspect of the present disclosure showing a container having a self-supporting element containing a fire suppressant;

FIG. 8 illustrates a perspective view of a separate retaining element; and

FIGS. 9 and 10 illustrate views of a fire suppressant material contained in a canister.

### DETAILED DESCRIPTION

Implementations described herein can be understood more readily by reference to the following detailed description, examples, and drawings. Elements, apparatus, and methods described herein, however, are not limited to the specific implementations presented in the detailed description, examples, and drawings. It should be recognized that these implementations are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all sub-ranges subsumed therein. For example, a stated range of “from about 250° F. to about 2200° F.” should be considered to include any and all sub-ranges beginning with a minimum value of 220° F. or more and ending with a maximum value of 2200° F. or less. Similarly, a stated range of from about 250° F. to about 1000° F. should be considered to include any and all sub-ranges beginning with a minimum value of 220° F. or more and ending with a maximum value of 1200° F. or less. Still further, a stated range of from about 250° F. to about 500° F. should be considered to include any and all sub-ranges beginning with a minimum value of 220° F. or more and ending with a maximum value of 520° F. of less.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

These and other implementations are described in greater detail in the detailed description which follows.

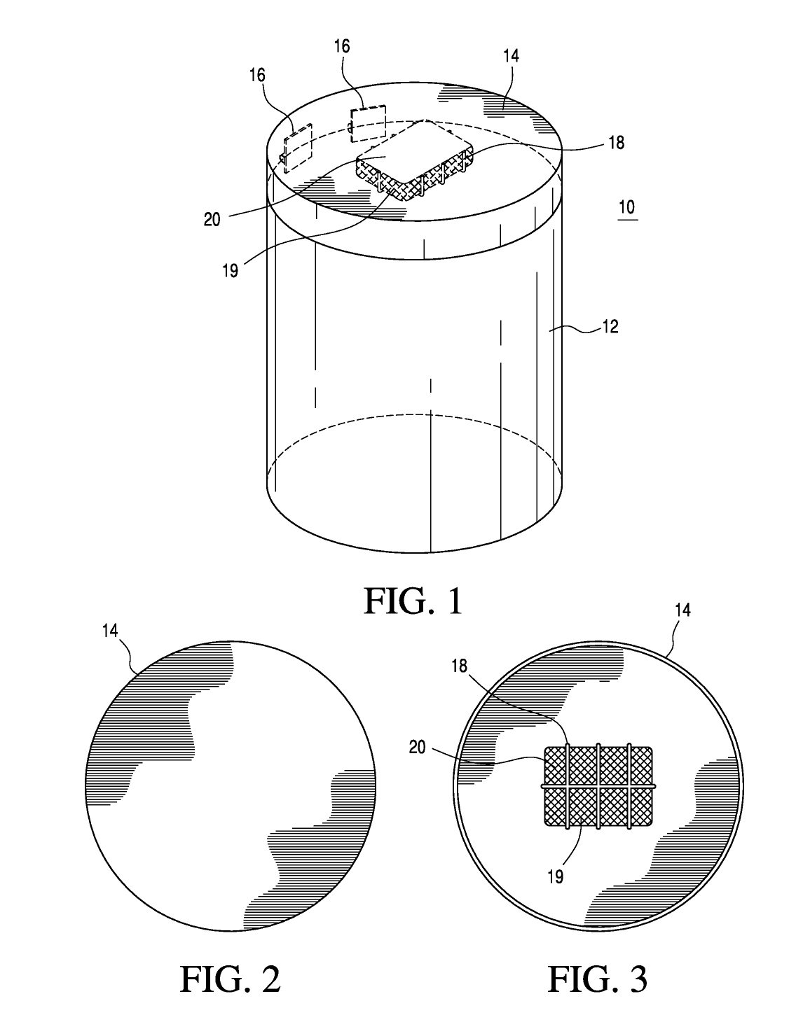

FIG. 1 is a perspective side view of one aspect of the invention. Container 10 is shown having a body section 12 and a lid 14. The lid 14 is shown secured to the body section 12 via hinges 16 that enable the lid 14 to be moved from a closed position to an open position, although it is understood that any type of fasteners can be used. In a further aspect (not shown), versions of the container are contemplated that have no hinges or fasteners. The present disclosure contemplates the use of any container configuration not inconsistent with the disclosure, and having a body section and a lid section dimensioned such that the lid section can be held in intimate contact with the body section.

Further, for purposes of the disclosure, the terms “container” and “receptacle” are interchangeable. In addition, the term “canister” as used in this specification refers to a device smaller than the containers and receptacles. “Canisters” are used to house the fire suppressant materials in certain aspects. The contemplated containers/receptacles and canisters may be made from any material not inconsistent with aspects of the present disclosure, and that can withstand and retain their structural integrity at, and preferably above, the typical ignition temperatures of any contents, including metal debris, etc. Materials including metal-containing and non-metal-containing materials are contemplated for fabricating the containers, including, without limitation, steels and steel alloys, stainless steels, refractory materials, ceramics, composite materials, etc. and combinations thereof.

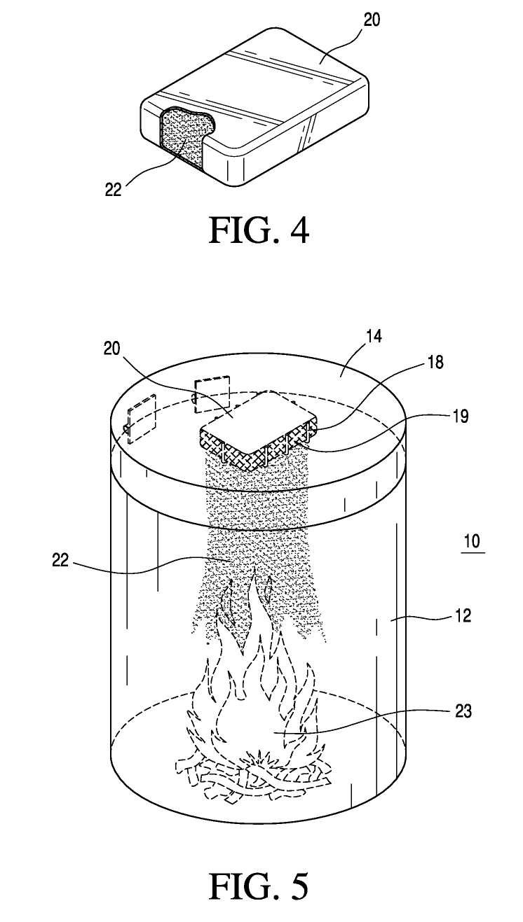

FIG. 2 illustrates an overhead view of the lid 14 and FIG. 3 illustrates the underside view of the lid 14 showing retaining element 18, retaining mesh 19 and fire suppressant packet 20. FIG. 4 shows a perspective view of the fire suppressant packet 20 encapsulating fire suppressant material 22. It is understood that the fire suppressant packet is made from any material that can react to heat and have a melting point low enough such that the packet ruptures before a fire in the receptacle burns out of control and beyond the capacity of the fire suppressant packet and the material contained therein to control such fire. Useful fire suppressant packet materials include polyethylene, polypropylene, poly(vinylchloride), polyurethane, polystyrene, poly(vinylacetal), paraffin, etc., and combinations thereof. It is understood that any material not inconsistent with the aspects of the present disclosure can be used to encapsulate the fire suppressant. When encapsulated, the preferred fire suppressant encapsulating packet is made from a material having a melting temperature of from about 250° F. to about 2200° F.

According to further aspects, the fire suppressant material may itself comprise a material suitable to bind the fire suppressant material into a solid or semi-solid form, such as, for example, a “cake”. In this aspect, any suitable binding material may be used such as, for example, a wax, or wax-containing compound, paraffin, etc., alone or in combination with other materials. See FIG. 8.

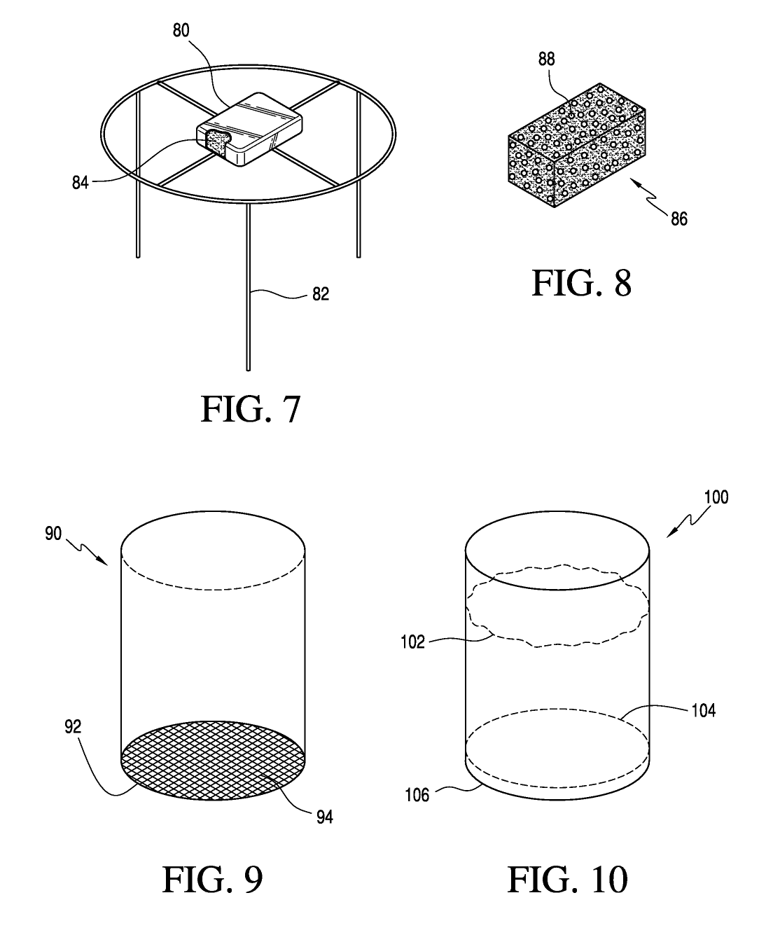

According to still further aspects, the fire suppressant material may be held in a predetermined location within the container, integrally, or through the aid of an additional supporting element, such as, for example, a bracket, rack, stand, etc. According to this aspect, the retention of fire suppressant material, “integrally”, within the container means that the fire suppressant is held within a feature of the container that is integral with the container itself, such as, for example, a fire suppressant cavity molded into the container itself as opposed to the material being retained in a feature, such as those listed above, that is added to the container for the purpose of holding the material in a desired location within the container. The supporting element can be a self-supporting structure. See FIG. 7. According to this and other aspects, the fire suppressant material may remain in a powder form, and may not be encapsulated, but may be held in a canister within the container/receptacle. The canister comprises a partially open end that may comprise a membrane capable of retaining the fire suppressant material under ambient conditions, and further capable of dissolving or burning away at a predetermined temperature. In this way, when a predetermined temperature within the container is achieved, the membrane in the canister gives way, exposing the partially open end of the canister and allowing the fire suppressant material to release in a predetermined fashion and a predetermined rate from the canister and onto the debris collected in the container. It is contemplated that the contents of the canister may be maintained at an elevated or ambient pressure. It is further understood that the partially open end of the canister may itself comprise a mesh, or a pattern of holes or other random or predetermined pattern of openings. The canister and its component parts may be made from any suitable metal-containing or non-metal-containing material not inconsistent with aspects of this disclosure. See FIGS. 9 and 10. According to further contemplated aspects, the entire canister may be made from a material that can itself respond to and otherwise react to elevated temperatures and disintegrate in predictable and predetermined fashion, in order to release the contained fire suppressant material.

The fire suppressant packet contains a predetermined amount of fire suppressant, at an elevated or ambient pressure, that is adequate when released from the packet, to cover a metal fire that may ignite in a receptacle. Useful fire suppressants for use in extinguishing a Class D metal fire include dry soda ash, sand, dry sodium chloride, dry sodium chloride-containing compounds, graphite powder, graphite-containing compounds, and combinations thereof.

It is further understood that the contemplated Class D fires include those fires where metals are ignited, including metals such as magnesium, potassium, titanium, zirconium, aluminum, lithium, calcium, and combinations thereof.

It is also understood that, while the present description focuses on extinguishing, containing and otherwise controlling Class D fires, especially in the workplace, the present disclosure contemplates that aspects of the present disclosure may be modified to extinguish, contain and otherwise control fires in classes other than Class D, such as including Class A, B, C, E and K fires. It is further understood that containers designed to address fires other than Class D fires may incorporate or be otherwise modified to accommodate a fire suppressant system such that the system provides the appropriate fire suppressant to address such non-Class D fires. Aspects of this disclosure further contemplate that, in certain instances, for example, instances where suffocation/oxygen deprivation is an appropriate extinguishing method, Class D fire suppressant may be used to extinguish additional fire types.

FIG. 5 shows a cross-sectional view of container 10 shown in FIG. 1. A fire 22 is shown burning within body section 12 of receptacle 10. Material 23 deposited within container 10 ignites. As the fire burns, heat from the fire reaches the fire suppressant packet 20 located on the underside of the lid 14, and optionally held in place via retaining element 18 and retaining mesh 19. At a predetermined temperature or temperature range, the fire suppressant packet 20 ruptures to predictably release a predetermined amount of fire suppressant material through retaining element 18 and retaining mesh 19 to contact the flames 22 and burning material 23.

As would be understood by those skilled in the field, the container/receptacle, the retainer and the retaining mesh may be made from any suitable material not inconsistent with the objectives of the present disclosure. Such suitable containers/receptacles, retaining elements and retaining meshes may be made from materials including steel, steel alloys, stainless steel, ceramic materials, etc., and combinations thereof. It is further understood that the retaining mesh may be an optional feature, and fire suppressant may be held in position within the receptacle by the retaining element alone.

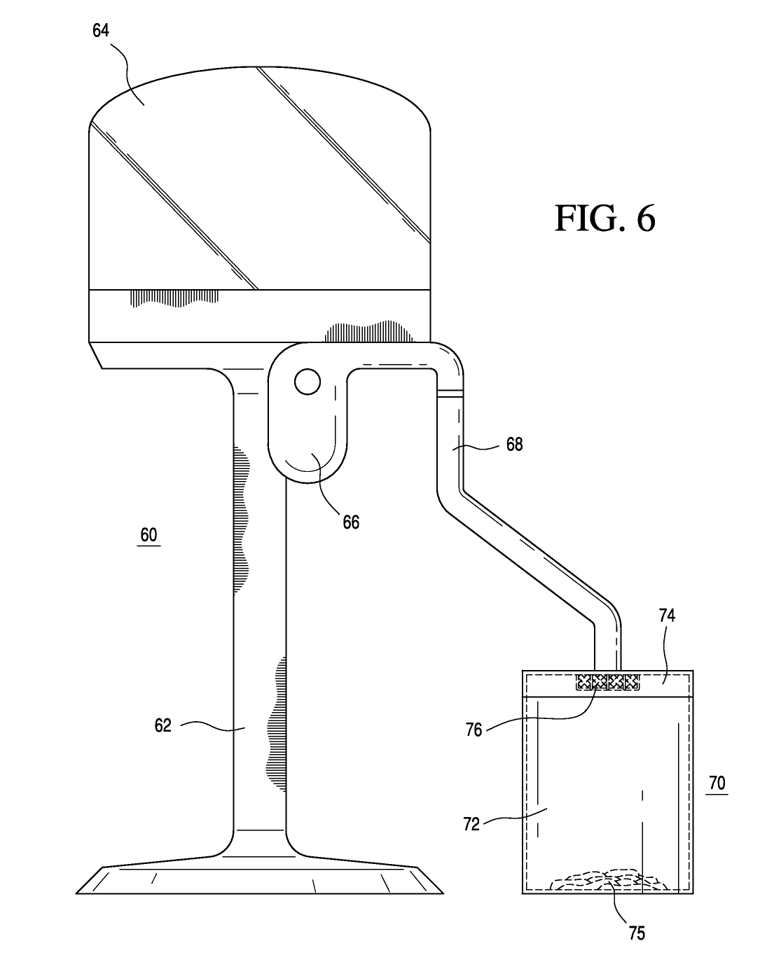

FIG. 6 shows one aspect of the present disclosure where an apparatus, such as, for example, a machine for machining metal 60 comprises a base 62 supporting a housing 64. Blower element 66 is connected to a pathway 68. During operation, metal is machined within housing 64. Metal shavings, turnings, and other metal debris are directed into pathway 68 by blower 66. The metal shavings, turnings and other metal debris are directed from pathway 68 into the body section 72 of container 70, shown in a cut-away view, and showing the deposited metal 75 at the bottom of container 70. Fire suppressant packet 76 is shown positioned at the underside of the lid 74.

Additional aspects of the invention provide for and include a self-supporting bracket, rack, stand, etc. that may be self-supporting and that is dimensioned to fit within the container. FIG. 7 shows a retainer element 80 attached to a retainer stand 82. Retainer stand 82 is dimensioned to fit within a container, such as the container shown in FIG. 1. Retainer element 80 is dimensioned to hold a predetermined amount of fire suppressant material 84. As will be readily understood, retainer stand 82 may be fashioned from any suitable metal-containing or non-metal containing material that is not inconsistent with the aspects of the present invention. The stand may be made from a material that can withstand the ignition temperature of metal debris that ignites within a container. At a desired temperature, the fire suppressant material would then be released from the retainer 80 and dispersed to engage the burning debris in the container. Further, it is contemplated that a stand may be made from a material that melts, sublimes, or otherwise disintegrates in a predictable fashion and rate, or otherwise collapses or is activated to release its contents at or about the ignition temperature of the debris in the container. In this aspect, the retainer stand 82 may collapse in a predictable fashion to assist in dispersing the fire suppressant material from the retainer onto the debris contained in the container.

FIG. 8 shows a further aspect, described-above, wherein a fire suppressant material itself comprises a binding material, such that the fire suppressant material is able to be formed into a solid, or semi-solid shape such as, for example, a “cake” or “brick”. As shown, fire suppressant material is shaped into a “cake” 86, comprising a binder material 88 incorporated into the “cake” 86.

Still further, FIG. 9 shows a canister 90 useful for holding a predetermined amount of fire suppressant material. A partially open end 92 comprises a mesh 94. As shown in FIG. 10, canister 100 further comprises a membrane 104 positioned between the fire suppressant material 102 and the mesh (not visible) at the partially open end 106 of canister 100.

The present disclosure further contemplates receptacles and containers that integrally contain fire suppressant materials other than Class D fire suppressant materials. Also contemplated are receptacles and containers that contain self-supporting elements that comprise fire suppressant materials other than Class D fire suppressant materials. Still further, the present disclosure contemplates receptacles and containers that are adapted to include or are otherwise attached to fire suppressant systems comprising fire suppressant materials other than Class D fire suppressant materials. More specifically, so-called Class A fires encompass of ordinary combustibles such as wood, paper, fabric, plastic and most kinds of trash that tend to leave an ash. In most cases, water or more complex types of fire suppressants, including CO₂, foams, etc. may be used to extinguish such a Class A fire. Class B fires typically encompass flammable liquids. Class C fires typically encompass flammable gases. In the cases of both Class B and Class C fires, fire suppressants typically such as dry chemicals, Halon, and FM-200 (a Halon replacement) inhibit the chain reaction of the fire. In some instances, CO₂, or for liquids, foams are also effective. However, water is not a recommended fire suppressant for many Class B and C fires as the application of water serves to scatter and spread the fire. Class E fires encompass electrical fires largely resulting from energized electrical equipment. The use of water and other conductive fire suppressants is obviously not recommended for extinguishing Class E fires. Instead, Class E fire suppressants include CO₂, FM-200 and dry powder fire suppressants such as, for example, Purple-K (PKP), Monnex (potassium allophanate), baking soda, etc. Finally, Class K fires encompass cooking oils and fats (kitchen fires). Low velocity water mist, as well as CO₂ and other dry powders (as well as suffocation or oxygen deprivation by placing lids on stovetop pot fires) are common fire suppressants known to usefully extinguish Class K fires.

Therefore, while primarily directed to the particular problems associated with extinguishing Class D metal fires, the present disclosure further contemplates aspects that are also directed to receptacles and containers adapted to include appropriately matched fire suppressants located within or connected to such receptacles and containers to extinguish or control other fires classified as Class A, B, C, E and K fires. As stated above, aspects of this disclosure further contemplate that, in certain instances, for example, instances where suffocation/oxygen deprivation is an appropriate extinguishing method, Class D fire suppressant may be used to extinguish additional fire types.

According to further aspects, the receptacles and containers of the present disclosure and their component parts may further comprise sensors and the ability to sense a fire by sensing, for example, temperature deviations and/or smoke. Such sensors may then communicate the presence of a fire from the receptacle to an alarm function located on the container and/or to a central and remote location such as a fire station and/or a central warning location at, or remote from, the location of the fire via any suitable communication network (such as, for example, a wireless network).

It is contemplated that the receptacles and containers of the present disclosure may therefore comprise the components necessary to sense a desired characteristic occurring within the container, such as, for example, a temperature, a rate of temperature increase, the presence of smoke, etc. Such sensors would be understood to be in communication with the required systems necessary to produce, receive and send a signal, for example, to and from a unit or system located remotely from the location of the container/receptacle. In this way, 24-hour monitoring of the container and the manufacturing apparatuses comprising such self-extinguishing containers can be achieved. As would readily be understood by one in the electronic and communication fields, such sensing, and sending and receiving of signaling, may be achieved wirelessly and may be directed to readouts in conventional computing systems (PCs, laptops, etc.) as well as to central receiving stations such as those used by first responders (e.g. fire stations, ambulance units, police stations, hospitals, etc.). It is also understood that signaling may be directed to a readout on a smart phone or other smart personal device including tablets, readers, etc.

Various implementations of the disclosure have been described in fulfillment of the various objectives of the disclosure. It should be recognized that these implementations are merely illustrative of the principles of the present disclosure. Numerous modifications and adaptations thereof will be readily apparent to those skilled in the art without departing from the spirit and scope of the disclosure.

What is claimed is:

1. A container comprising:
an inner surface and an outer surface; and
a system for suppressing a fire occurring in the container, said system positioned within the container, said system comprising a predetermined amount of fire suppressant material.

2. The container of claim 1, wherein the amount of fire suppressant material is located adjacent to the inner surface.

3. The container of claim 1, further comprising a retainer dimensioned to retain a predetermined amount of fire suppressant material, said retainer in communication with the inner surface of the container.

4. The container of claim 1, further comprising a lid section, said lid section comprising an inner and outer surface, and said inner surface comprising a predetermined amount of fire suppressant material.

4. The container of claim 3, wherein the retainer is integrated in an element dimensioned to fit within the container.

6. The container of claim 3, wherein the retainer is integral with the inner surface of the container.

7. The container of claim 3, wherein the retainer comprises a mesh section.

8. The container of claim 7, wherein the mesh is made from a metal-containing material.

9. The container of claim 6, wherein the lid section comprises a retainer, and said retainer provides at least a partial boundary for a cavity located in the second side of the lid section.

10. The container of claim 1, wherein the container is in communication with a source of metal debris to be contained within the container.

11. The container of claim 1, wherein the fire suppressant material is selected from the group consisting of: dry soda ash, sand, dry sodium chloride, sodium chloride-containing compounds, graphite powder, graphite-containing compounds, and combinations thereof.

12. The container of claim 1, wherein the fire suppressant material is encapsulated.

13. The container of claim 1, wherein the fire suppressant material is encapsulated in an encapsulating material having a melting point of from about 250° F. to about 2200° F.

14. The container of claim 13, wherein the encapsulating material comprises a material selected from the group consisting of: polyethylene, polypropylene, poly(vinyl chloride), polyurethane, polystyrene, poly(vinylacetal), paraffin, and combinations thereof.

15. The container of claim 1, wherein the fire suppressant material comprises an encapsulating material.

16. The container of claim 1, wherein the fire suppressant is a Class D fire suppressant.
